(19) United States
(12) Patent Application Publication
(10) Pub. No.: US 2014/0143671 A1
(43) Pub. Date: May 22, 2014

(54) DUAL FORMAT AND DUAL SCREEN EDITING ENVIRONMENT

(71) Applicant: AVID TECHNOLOGY, INC., Burlington, MA (US)

(72) Inventor: Albert Kovalick, Santa Clara, CA (US)

(73) Assignee: AVID TECHNOLOGY, INC., Burlington, MA (US)

(21) Appl. No.: 13/680,162

(22) Filed: Nov. 19, 2012

(51) Int. Cl. G06F 3/048

(52) U.S. Cl. CPC G06F 3/048
USPC 715/723; 715/716

(57) ABSTRACT

Methods and systems for multi-screen media authoring include displaying an integrated graphical user interface with a timeline for first screen linear time-based media editing and a second timeline for editing second screen content associated with the first screen content. Second screen content includes a sequence of modules that involve active viewer interaction and/or passive consumption. The display of the first and second timelines are temporally aligned with each other, and enable time-line-based editing of second screen content synchronized to the first screen. Selection of a second screen module on the second timeline invokes an editing environment corresponding to the type of module selected. Integrated monitors show end user or proxy views of first and second screen content corresponding to the first and second timelines respectively.

### BACKGROUND

An increasing number of consumers use a second screen while watching television programs. The television program typically plays on a conventional screen, while the second screen is a portable device, such as a laptop, tablet, or smartphone. The second screen enables viewers to access materials that are related to the television program. Typically, the primary screen displaying the television program is connected to cable, satellite, IPTV, or a terrestrial broadcast, while the second screen is synchronized to the primary program and receives content via the web. There may be several primary screen viewers each with a secondary, personal screen.

The design of the second screen content is based on the primary screen content. In many cases it is precompiled, e.g., formatted as HTML, and available in real time to viewers. FIG. 1 illustrates a typical arrangement, with a television primary screen 102 and a tablet second screen 104. This type of viewing experience is a new form of interactive TV. Rather than overlay auxiliary information onto the primary screen, which may cause excessive clutter, the second screen becomes the interactive venue. Each viewer can interact with their personal screen based on the choices presented. The content is generally text or graphics, but may also be low resolution video or animation. In one model, second screen content is continually pushed (e.g., streamed) to the second screen without viewer involvement. A second model enables users to interact with the second screen as desired.

There are several ways for the second screen to be aware of the primary screen content, whether it is a live channel, or prerecorded programming, such as from a DVR or DVD. One method uses audio fingerprinting to classify the content, for example with second screen built-in microphone 106 that records audio 108 from the primary screen to create a real-time audio fingerprint. The tablet then provides this to a web-based query service 110 (i.e., an audio fingerprint match server) which in turn returns the main screen content identity. When the primary content is changed, the secondary screen is kept in sync. Using the received primary content identity, the second screen connects to web feeds 112 that are related to (and synchronized with) the program on the primary screen.

The two-screen experience can be adapted to function effectively for both live and delayed screen delivery means, such as DVD, DVR, file, and video streaming service. Regardless of the delivery method, a quality experience for the consumer's second screen is needed. There is a need for content creation tools to support the creation and delivery of this second screen content.

### SUMMARY

In general, the methods, systems, and computer program products described herein assist an editor in the creation of time-synced second screen content in a variety of formats.

In general, in a first aspect, a computer-implemented method for multi-screen media authoring involves displaying a graphical user interface that includes: a first timeline for first screen content, wherein the first screen content comprises linear time-based media; and a second timeline for second screen content. wherein the second screen content is associated with the first screen content, and wherein the display of the first and second timelines are temporally aligned with each other; and enabling a user to edit the second screen content by performing editing operations based on the second timeline.

Various embodiments include one or more of the following features. The second screen content comprises a sequence of modules wherein each of the modules is defined in part by a module type. The plurality of module types includes a passive type and an interactive type. The second timeline includes a main track indicating a content of each of the modules and one or more sub-tracks, each of the one or more sub-tracks indicating a given property of each of the corresponding one of the modules on the main track. The given property comprises one of a module type and a module edit status. The method further includes enabling the user to select a portion of a sub-track, wherein the portion is defined by a temporal span of the sub-track; and displaying details of one or more modules that overlap with the selected temporal span, wherein the displayed details relate to the given property indicated by the selected sub-track. The editing operations include inserting a module of second screen content into a sequence of modules of second screen content on the second timeline. The editing operations include editing a selected module of second screen content using an editing application associated with the type of the selected module. The editing application associated with the type of the selected module is launched automatically when the selected module is selected. The selected module comprises a web page and the first screen content comprises a video program, and editing the editing application enables the user to create a web page synchronized to a specified frame of the video program. The editing operations include adjusting at least one of a start time and an end time of a module of the sequence of modules, and moving a module from a first location in the second timeline to a second location in the second timeline. The method further includes enabling the user to advance or back up to a temporal location within a multi-screen media program being authored, wherein the temporal location is defined by selecting a module corresponding to the temporal location. The editing operations include inserting a sync point at a sync location on the second timeline, wherein the sync point indicates synchronization between second screen content at the sync location and a specified temporal location in the first screen content. The method further includes enabling the user to edit the first screen content by performing editing operations on the first timeline. The graphical user interface includes a region for displaying a view of at least one of the first screen content and the second screen content. The second screen content includes at least one of a form, a real-time data feed, a social network feed, and an embedded time-based media program.

In general, in a second aspect, a computer program product comprises: a non-transitory computer-readable medium with computer program instructions encoded thereon, wherein the computer program instructions, when processed by a computer, instruct the computer to perform a method for multi-screen media authoring, the method comprising: displaying a graphical user interface that includes: a first timeline for first screen content, wherein the first screen content comprises linear time-based media; and a second timeline for second screen content, wherein the second screen content is associated with the first screen content, and wherein the display of the first and second timelines are temporally aligned with each other; and enabling a user to edit the second screen content by performing editing operations based on the second timeline.

In general, in a third aspect, a system for multi-screen media authoring comprises: a memory for storing computer-readable instructions; and a processor connected to the memory, wherein the processor, when executing the computer-readable instructions, causes the multi-screen media authoring system to: display a graphical user interface that includes: a first timeline for first screen content, wherein the first screen content comprises linear time-based media; and a second timeline for second screen content, wherein the second screen content is associated with the first screen content, and wherein the display of the first and second timelines are temporally aligned with each other; and enable a user of the system to edit the second screen content by performing editing operations based on the second timeline.

### BRIEF DESCRIPTION OF THE DRAWINGS

FIG. 1 is an illustration of a prior art second screen arrangement for consuming secondary content related to the primary program.

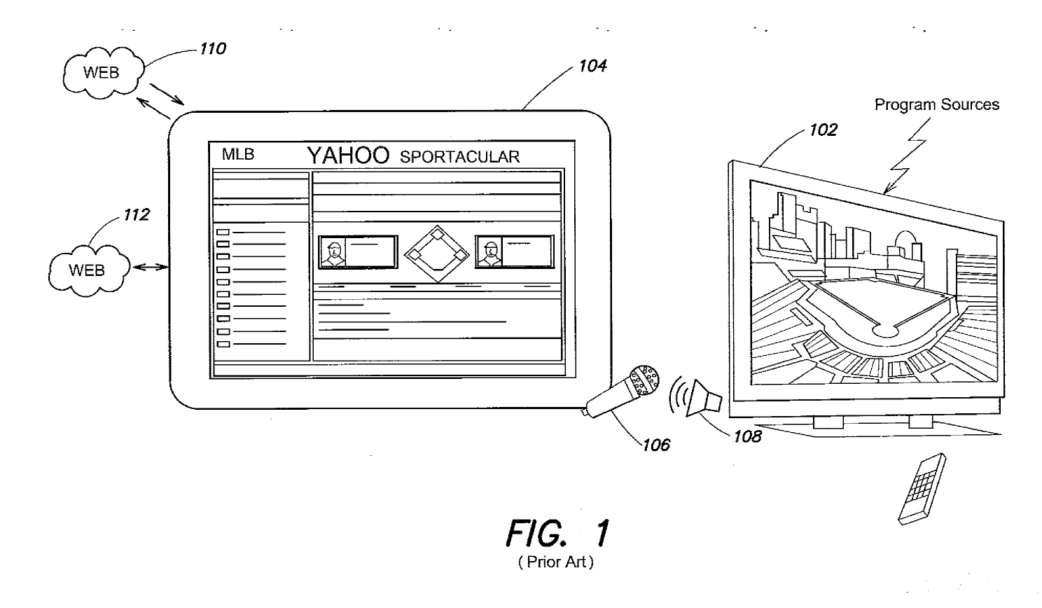

FIG. 2 illustrates basic elements of two screen authoring and consumption environments.

FIG. 3 illustrates a user interface for a two screen authoring environment.

FIG. 4 illustrates a two-screen viewing mode for a two screen authoring environment.

### DETAILED DESCRIPTION

The second screen opens up new opportunities for viewers who enjoy multi-tasking while watching television. The increasing diversity and ubiquity of portable devices such as smartphones and tablets means that many already have devices that can support the second screen. The increase in the use of multi-screen programming causes an expansion of the diversity and quality of second screen content, and generates a need for authoring tools specifically designed to create and compile content for the second screen. Secondary content includes interactive material, social networks, material that is auxiliary to the primary content, live event information, commentary, statistics, advertisements, polls, and play-along capabilities. The second screen provides new scope for advertising, such as synchronized advertisements, hotspot ads, and general advertisements that reinforce and augment an advertisement on the main screen or offer a partially related or unrelated advertisement. Examples of primary screen content that lend themselves to associated second screen content include pre-made episodics, premade general programming, movies and dramas, live sporting events, live and semi-live events such as concerts, live breaking news broadcasts, and scheduled news programs. For many of these examples, the time taken to prepare the second screen content is critical, which depends not only on the programming task, but the time required to obtain access to compelling material. For example, for a live golf match, some of the second screen material may need to be compiled during the match in a matter of minutes and seconds, while other content can be precompiled over a period of weeks and months.

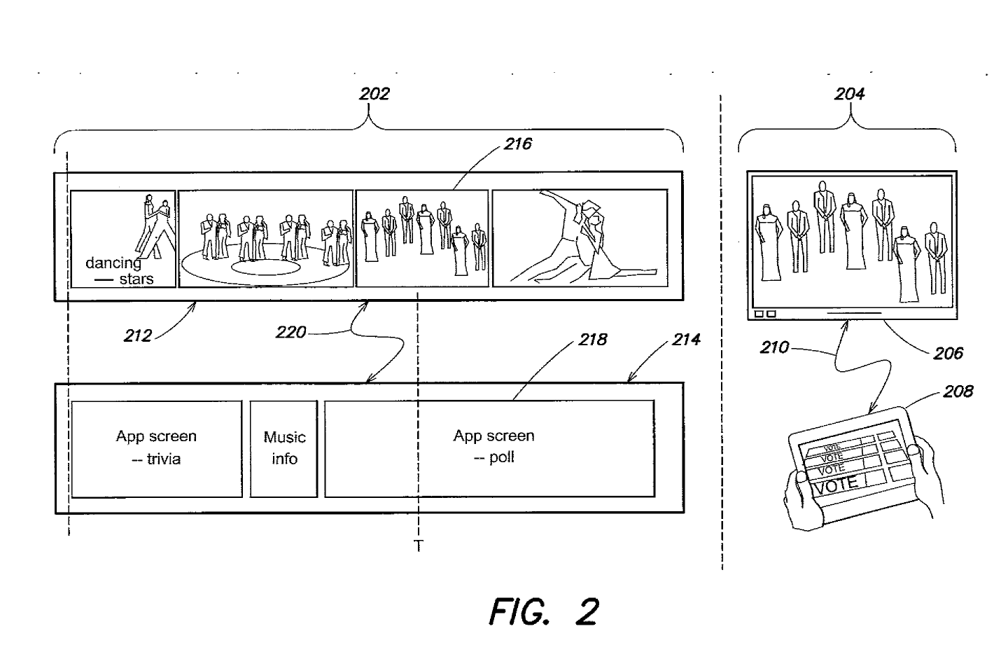

Ease of authoring and access to compelling material for second screen content is needed in order to support both long latency (one or more days), near real time, or real time content creation. We now describe an exemplary development environment to support such secondary content authoring. Basic aspects of the two-screen authoring and consumption environments are illustrated in FIG. 2, The authoring environment (202) is shown on the left side of the figure, and the consumption environment (204) is shown at right. In the consumption environment, first screen 206 displays traditional time-based media, such as audio-visual (AV) material, and secondary material is displayed on second screen 208. Unlike the first screen content, which is generally in a linear AV format, the second screen content format may take a variety of forms. In one common example, the second screen content is browser-like in form, such as time-code aware HTML/Javascript. This format may be decoded by a second screen client such as a tablet device or laptop. Other formats include application-specific coding technologies, such as those used by Adobe® AIR® and Adobe Flash® from Adobe Systems, Inc, San Jose, Calif., and Silverlight® from Microsoft Corporation, Redmond, Wash. The second screen content may also include traditional AV material. The primary and secondary screens are maintained in temporal synchronization (210) during viewing by using technologies such as audio fingerprinting, as referred to above.

Authoring environment 202 includes first screen time-line 212 and second screen timeline 214. First screen timeline 212 comprises a sequence of clips, such as clip 216, which are the basic elements used for editing a traditional AY program in a non-linear editing environment. In second screen timeline 214, the analogous basic element of second screen content is referred to as an “App module,” or simply “module,” and the second screen timeline is built up with a sequence of such modules, such as poll module 218. The authoring environment maintains temporal synchronization (220) between the first screen and second screen timelines, with each timeline displayed along a common time axis, such that for horizontally disposed timelines, such as those illustrated in FIG. 2, events that occur at the same time are displayed on the timeline at the same horizontal (i.e., x) coordinate on the display. Similar alignment is maintained in the case of vertically disposed timelines by aligning the vertical (i.e., y) coordinate of contemporaneous events.

For static modules (which includes interactive modules), the module is temporally synchronized with the first screen timeline at the start and at the end, without a sense of time within the module. Thus, a module starting at time Tₛₜₐᵣₜ and ending at time T_{end} may have interactive aspects during the duration (T_{end}−Tₛₜₐᵣₜ) without synchronization within the module. In the example illustrated in FIG. 2, at time T, the AV program on the first screen is playing at a location within clip 216, and the second screen content is running static module 218, which spans time T in second screen timeline 214, and is a poll relating to the program on the first screen. For dynamic modules, such as streaming modules that include a video clip, the module does have a sense of time, with optional temporal synchronization within the module as well as at the start and end locations. As indicated in the figure, start and end locations of modules may or may not correspond to AV clip boundaries in the first screen timeline. The program timelines are used for editing operations for the content destined for their respective screens.

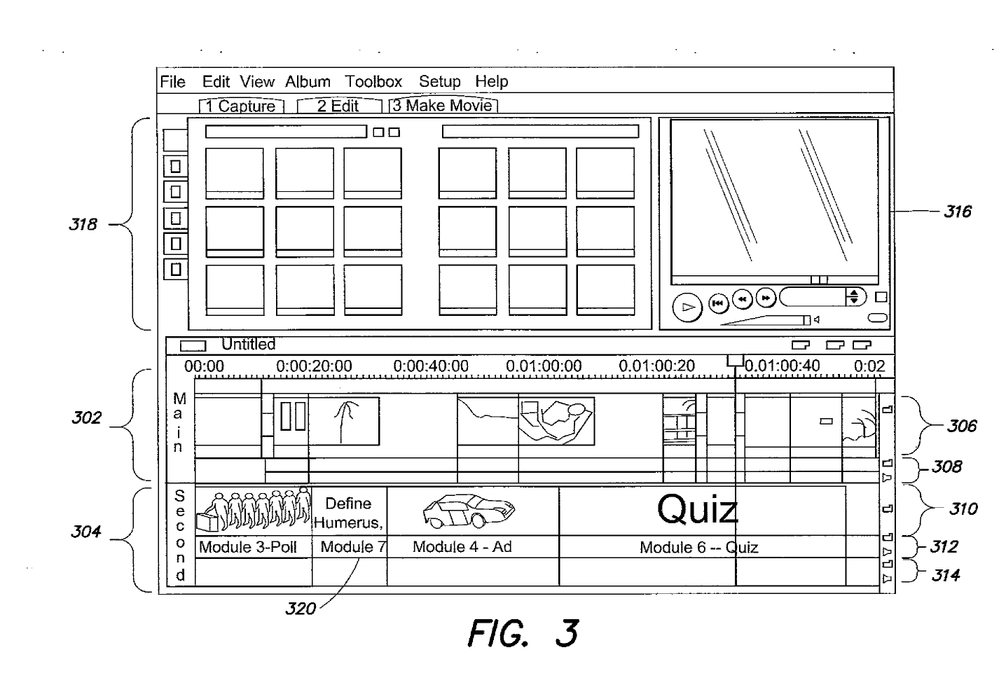

FIG. 3 is a diagrammatic screen shot of a graphical user interface for combined authoring environment 202. The UI shows first screen timeline 302 and second screen timeline 304. Both timelines may be edited, and are maintained in sync throughout the editing process. Each timeline may have a main track and several sub-tracks, together forming a collective timeline. Collective first screen timeline 302, in addition to main track 306, may include other tracks 308, such as tracks for other AV, text, and graphics, as used in traditional non-linear video editing systems. For second screen collective timeline 304, main track 310 is a sequence of App modules side by side. each of which is annotated with an indication of the content and function of the module such as a key frame image, text, or an icon. Locked to main track 310 are one or more sub-tracks that contain module associated elements, such as overlay, metadata, dynamic data (such as statistics and news feeds), or editing status. In the example illustrated in FIG. 3, the second screen sub-tracks include sub-track 312 for module type and edit status, with each module annotated, e.g., with color, to indicate whether the module is completed, being worked on, or empty. Text or graphics indicates the module type, e.g., poll, ad, or quiz. Second sub-track 314 indicates the module activity type, e.g., passive or interactive. Some module associated elements may not be locked to an associate module in the master track, instead spanning multiple modules and even having start/end times that do not coincide with corresponding module start/end times. Examples of module associated elements that may span more than one module include a sound track such as a narration in a second language, lower screen crawl such as sports statistics, a corner score graphic, or other elements common to more than a single module.

The upper portion of the combined authoring environment illustrated in FIG. 3 includes monitor area 316 and project resource area 318. The monitor area displays one or two monitor windows showing a proxy view of the first screen AV program according to first screen timeline 302, and/or a view of the second screen content corresponding to second screen timeline 304. Project resource area 318 shows the AV clips and App module resources that are available to the user for inclusion in the first screen and second screen timelines respectively. Resources may appear as key frames or as other distinctive images indicating the nature of the resource. Module resources may be individually authored outside the described authoring environment, such as in customized development environments. Certain resources may be authored or modified by invoking a content management system (CMS), as described below. In various embodiments, a CMS is opened by selecting a module directly in the second screen timeline.

The combined authoring environment discussed above enables a user to edit both the first screen and the second screen program. First screen content may be edited in a non-linear video editing environment, such as that provided by Media Composer® from Avid Technology, Inc., of Burlington, Mass. In a more restrictive mode, the authoring environment only permits editing of the second screen timeline, while the primary timeline is view-only. In this mode, first screen timeline 302 represents a view-only flat AV file that may not be edited, and the project resource area is limited to showing module choices for the second screen timeline.

We now describe second screen timeline editing operations that are enabled by the authoring environment. Clicking on a module frame in the timeline activates either an editing/authoring application associated with the selected module or a proxy viewer for the module, which shows any resource as it would appear on the second screen, and appears either in the monitor window or in a full-screen version. The editing application may be a local application, such as a web page composition tool or a text editor, or it might be a CMS linked to the selected module, either locally or cloud-based. A custom CMS may be invoked for editing of template-based modules. For example, “HTML” tracks may be edited using a CMS such as Drupal™, an open source content management platform. A first level of module editing involves using an existing template, such as to create poll questions, quizzes, or add definitions. A second level of module editing enables new modules to be created from scratch using applications and CMS's available to the user. A module may initially be identified using a place-holder indicating that the module needs development. Selecting the place-holder icon opens the CMS to enable module authoring. Other tools enable dynamic data formats to be integrated into App pages, such as to show news crawls, weather, and other real time data.

Selecting a module associated element, such as for example an element on type and status sub-track 312, opens a slate that expands the element. For example, clicking on sub-track 312 element 320 annotated “Module 7” would bring up a slate with details about a definition module, such as its function (to define words), its purpose (to add to a viewer's understanding of a story), and, if applicable, various trivia about the item.

The authoring environment enables users to manipulate timeline elements, including stretching, reducing, resizing, moving, and dragging and dropping elements. Certain operations for some modules are tied to their associated CMS. For example, a CMS for a module template may permit text and graphical elements to be resized or text to be added or modified. Some template elements may be locked for editing. In the two-timeline editing mode, these manipulations are enabled for both timelines, while in the restrictive mode, they are only enabled for the second screen timeline.

Since the time taken to complete an interactive module depends on actions of the viewer, the duration assigned to a module on the timeline may not be optimal for a given user. The second timeline editor is able to specify how the duration of a module may override the time span allotted to it in the timeline. In the default case, the module closes automatically upon reaching the endpoint allotted in the timeline. Other options include allowing the module to remain open and active for a pre-determined finite or indefinite overrun period. During the overrun, the first screen may pause, or alternatively the first screen may continue, and when the extended module is completed or closes, the second screen timeline advances to the current play-back location of the first screen, thus potentially skipping one or more intervening modules.

The user interface viewing window may be moved forward or backward in a manner similar to the operations in a non-linear editing system, e.g., jogging, shuttling, etc. The second screen timeline permits the user to use an additional operation referred to as the skip operation. This enables skipping to a specified module, e.g., by selecting a module characterized by one of the module associated elements. For example, the user could skip to the next module having an incomplete status, or skip back and forth between interactive modules.

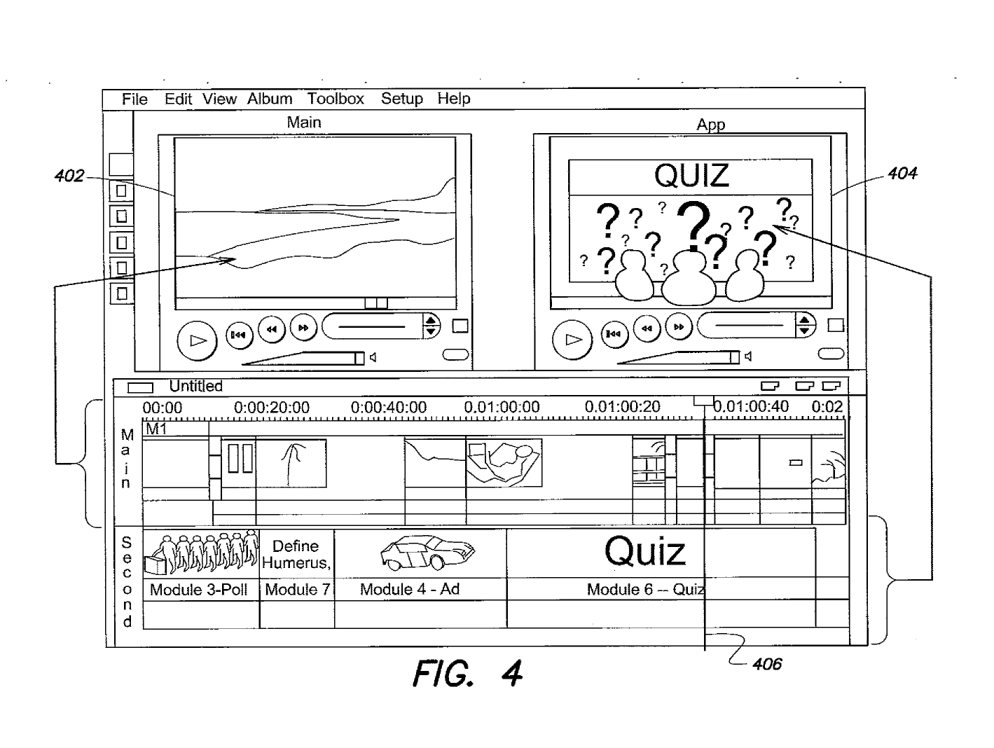

The combined authoring environment offers users a choice of viewing modes. In one mode, two viewports are provided, as shown in FIG. 4, with the first screen timeline viewed on left proxy monitor 402 and the second screen module timeline viewed on right proxy monitor 404. The two views are time-synchronized and correspond to the first screen and second screen content at the time indicated by timeline cursor 406. The second screen monitor shows the end user view. For interactive modules, the end-user preview may act as a mini-browser window, enabling the author to use the mouse to interact with the contents of window 404. Alternatively, a proxy view may not have the same interactivity as that to be experienced by the second screen end user, for example, when the proxy monitor does not have the same interactive capabilities as the target second screen device, such as a touch screen.

In the embodiment described above, the authoring environment enables two simultaneous timelines to be edited within the same user interface. In various other embodiments, the environment includes multiple collective timelines, each with its own format (AV, HTML, Flash, custom, etc.), thus enabling more than two programs to be edited simultaneously and in temporal synchronization. Multiple AV timelines facilitate the authoring of programs that include multiple aligned AV programs, such as are used in digital signage and installations with multiple monitors that are in sync with each other. Multiple collective Module (App) timelines, either with the same formats or different formats (e.g., HTML, Flash, App-specific) enable effective authoring for multiple end user formats.

In order to integrate a conventional AV program timeline with an essentially non-time based authoring UI (e.g. a CMS), the environment enables a variety of synchronization points to be inserted into the non-linear modules (second screen material), e.g., between screen changes, that may be tied to a specific temporal location in the corresponding AV program (first screen material), such as a SMPTE timecode. Each module has a timecode value associated with it. For example, a textual bio for an actor that is to be shown on the second screen for 10 seconds has a timecode duration indicating the length of time the actor bio is to be displayed to the user. In effect, the second screen server “pushes” content to the user in accordance with the duration of the content of any given module. As mentioned above, end-point times may be overridden by the user at the discretion of the author of the second screen content.

The various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, liquid crystal displays (LCD), plasma displays, various stereoscopic displays including displays requiring viewer glasses and glasses-free displays, cathode ray tubes, video projection systems and other video output devices, printers, devices for communicating over a low or high bandwidth network, including network interface devices. cable modems, and storage devices such as disk or tape. One or more input devices may be connected to the computer system. Example input devices include, but are not limited to, a keyboard, keypad, track ball, mouse, pen and tablet, touchscreen, camera, communication device, and data input devices. The invention is not limited to the particular input or output devices used in combination with the computer system or to those described herein.

The computer system may be a general purpose computer system which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet. The connected network may transfer to and from the computer system program instructions for execution on the computer, media data such as video data, still image data, or audio data, metadata, review and approval information for a media composition, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor. or information stored on the disk to be processed by the application program. The invention is not limited to a particular memory system. Time-based media may be stored on and input from magnetic, optical, or solid state drives, which may include an array of local or network attached disks.

A system such as described herein may be implemented in software or hardware or firmware, or a combination of the three. The various elements of the system, either individually or in combination may be implemented as one or more computer program products in which computer program instructions are stored on a non-transitory computer readable medium, for execution by a computer, or transferred to a computer system via a connected local area or wide area network. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A computer-implemented method for multi-screen media authoring, the method comprising:
displaying a graphical user interface that includes:
a first timeline for first screen content, wherein the first screen content comprises linear time-based media; and
a second timeline for second screen content, wherein the second screen content is associated with the first screen content, and wherein the display of the first and second timelines are temporally aligned with each other; and
enabling a user to edit the second screen content by performing editing operations based on the second timeline.

2. The method of claim 1, wherein the second screen content comprises a sequence of modules and wherein each of the modules is defined in part by a module type.

3. The method of claim 2, wherein the plurality of module types includes a passive type and an interactive type.

4. The method of claim 2, wherein the second timeline includes a main track indicating a content of each of the modules and one or more sub-tracks, each of the one or more sub-tracks indicating a given property of each of the corresponding one of the modules on the main track.

5. The method of claim 4, wherein the given property comprises one of a module type and a module edit status.

6. The method of claim 4, further comprising:
enabling the user to select a portion of a sub-track, wherein the portion is defined by a temporal span of the sub-track; and
displaying details of one or more modules that overlap with the selected temporal span, wherein the displayed details relate to the given property indicated by the selected sub-track.

7. The method of claim 2, wherein the editing operations include inserting a module of second screen content into a sequence of modules of second screen content on the second timeline.

8. The method of claim 2, wherein the editing operations include editing a selected module of second screen content using an editing application associated with the type of the selected module.

9. The method of claim 8, wherein the editing application associated with the type of the selected module is launched automatically when the selected module is selected.

10. The method of claim 8, wherein the selected module comprises a web page and the first screen content comprises a video program, and wherein editing the editing application enables the user to create a web page synchronized to a specified frame of the video program.

11. The method of claim 2, wherein the editing operations include adjusting at least one of a start time and an end time of a module of the sequence of modules.

12. The method of claim 2, wherein the editing operations include moving a module from a first location in the second timeline to a second location in the second timeline.

13. The method of claim 2, further comprising enabling the user to advance or back up to a temporal location within a multi-screen media program being authored, wherein the temporal location is defined by selecting a module corresponding to the temporal location.

14. The method of claim 1, wherein the editing operations include inserting a sync point at a sync location on the second timeline, wherein the sync point indicates synchronization between second screen content at the sync location and a specified temporal location in the first screen content.

15. The method of claim 1, further comprising enabling the user to edit the first screen content by performing editing operations on the first timeline.

16. The method of claim 1, wherein the graphical user interface further includes a region for displaying a view of at least one of the first screen content and the second screen content.

17. The method of claim 1, wherein the second screen content includes at least one of a form, a real-time data feed, a social network feed, and an embedded time-based media program.

18. A computer program product comprising:
a non-transitory computer-readable medium with computer program instructions encoded thereon, wherein the computer program instructions, when processed by a computer, instruct the computer to perform a method for multi-screen media authoring, the method comprising:
displaying a graphical user interface that includes:
a first timeline for first screen content, wherein the first screen content comprises linear time-based media; and
a second timeline for second screen content, wherein the second screen content is associated with the first screen content, and wherein the display of the first and second timelines are temporally aligned with each other; and
enabling a user to edit the second screen content by performing editing operations based on the second timeline.

19. A system for multi-screen media authoring, the system comprising:
a memory for storing computer-readable instructions; and
a processor connected to the memory, wherein the processor, when executing the computer-readable instructions, causes the multi-screen media authoring system to:
display a graphical user interface that includes:
a first timeline for first screen content, wherein the first screen content comprises linear time-based media; and
a second timeline for second screen content, wherein the second screen content is associated with the first screen content, and wherein the display of the first and second timelines are temporally aligned with each other; and
enable a user of the system to edit the second screen content by performing editing operations based on the second timeline.
